(19) United States
(12) Patent Application Publication
(10) Pub. No.: US 2017/0103182 A1
(43) Pub. Date: Apr. 13, 2017

(54) Modelling Disease Progression and Intervention Effects Using Non-Clinical Information Proxies for Clinical Information

(71) Applicant: International Business Machines Corporation, Armonk, NY (US)

(72) Inventors: Saheed Akineinde, lle-lfe (NG); Michal Rosen-Zvi, Jerusalem (IL); Lavi Shpigelman, Jerusalem (IL); Omer Weissbrod, Rehovot (IL)

(21) Appl. No.: 14/604,731

(22) Filed: Jan. 25, 2015

(51) Int. Cl. G06F 19/00; G06N 7/00

(52) U.S. Cl. CPC G06F 19/3437; G06N 7/005

(57) ABSTRACT

Modelling disease progression using non-clinical information proxies for clinical information, by accessing a computer-based Bayesian model of the progression of a disease, adapting the Bayesian model to include one or more clinical factors that are believed to influence progression of the disease, adapting the Bayesian model to include one or more non-clinical proxies for one or more clinical factors that are believed to influence progression of the disease, identifying interdependencies among variables of the Bayesian model based on a meta-analysis of literature associated with any of the disease, the clinical factors, and the non-clinical proxies, providing values for any of the variables of the Bayesian model, and presenting any portion of the Bayesian model via a computer-based output device.

### BACKGROUND

Clinicians and medical researchers often apply statistical methods to information about disease progression and clinical data to infer the relative effects of various potential disease interventions. Unfortunately, in many cases, sufficient relevant clinical data might not be available, which can negatively affect healthcare planning and management.

### SUMMARY

In one aspect of the invention a method is provided for modelling disease progression using non-clinical information proxies for clinical information, the method including accessing a computer-based Bayesian model of the progression of a disease, adapting the Bayesian model to include one or more clinical factors that are believed to influence progression of the disease, adapting the Bayesian model to include one or more non-clinical proxies for one or more clinical factors that are believed to influence progression of the disease, identifying interdependencies among variables of the Bayesian model based on a meta-analysis of literature associated with any of the disease, the clinical factors, and the non-clinical proxies, providing values for any of the variables of the Bayesian model, and presenting any portion of the Bayesian model via a computer-based output device.

In other aspects of the invention systems and computer program products embodying the invention are provided.

### BRIEF DESCRIPTION OF THE DRAWINGS

Aspects of the invention will be understood and appreciated more fully from the following detailed description taken in conjunction with the appended drawings in which:

FIG. 1 is a simplified conceptual illustration of a system for modelling disease progression using clinical information and non-clinical information proxies for clinical information, constructed and operative in accordance with an embodiment of the invention;

FIG. 2 is a simplified flowchart illustration of an exemplary method of operation of the system of FIG. 1, operative in accordance with an embodiment of the invention; and

FIG. 3 is a simplified block diagram illustration of an exemplary hardware implementation of a computing system, constructed and operative in accordance with an embodiment of the invention.

### DETAILED DESCRIPTION

Embodiments of the invention may include a system, a method, and/or a computer program product. The computer program product may include a computer readable storage medium (or media) having computer readable program instructions thereon for causing a processor to carry out aspects of the invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

Aspects of the invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

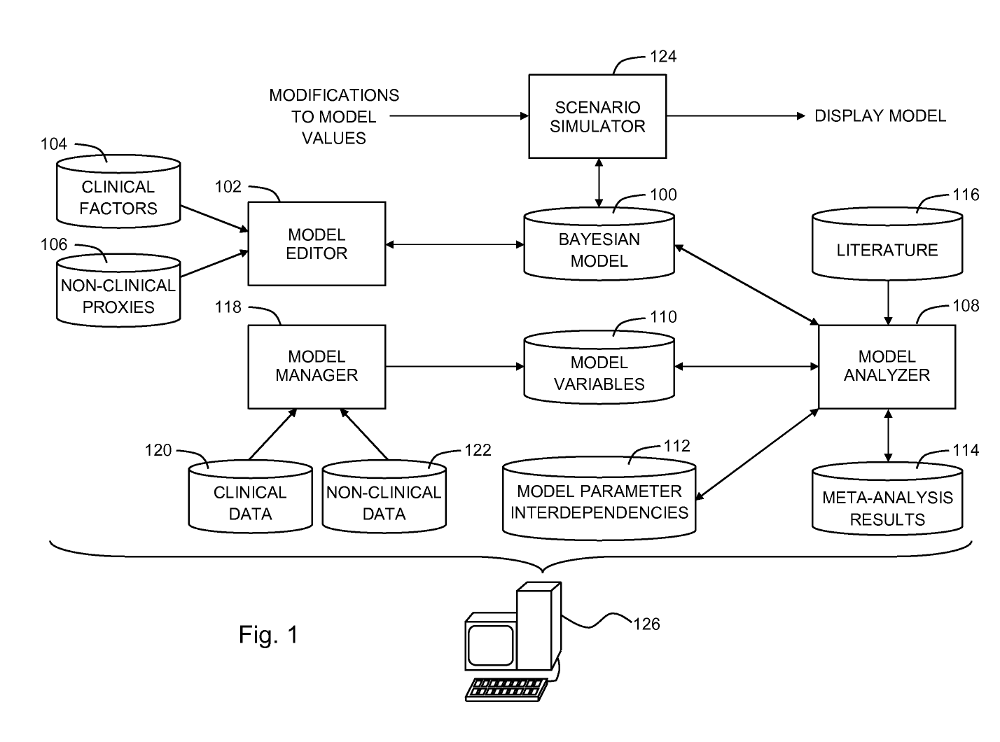

Reference is now made to FIG. 1 which is a simplified conceptual illustration of a system for modelling disease progression using non-clinical information proxies for clinical information, constructed and operative in accordance with an embodiment of the invention. In the system of FIG. 1 a computer-based Bayesian model 100 of the progression of a disease is accessed, such as the model introduced by Myers, et al. (Myers E R, McCrory D C, Nanda K, Bastian L, and Matchar D, “Mathematical Model for the Natural History of Human Papillomavirus Infection and Cervical Carcinogenesis,” Am. J. Epidemiology, Vol. 151, No. 12, pp. 1158-1171, June, 2000), where model 100 is implemented using a computer in accordance with conventional techniques.

A model editor 102, such as the Bayes Net Toolbox by Kevin Murphy, available at http://bnt.googlecode.com/svn/trunk/docs/usage.html, is configured to adapt model 100 to include one or more clinical factors 104 that are believed to influence progression of the disease, such as by adapting model 100 to include potential interventions actions such as awareness campaigns, disease screening, and vaccination, such as is described by Austin, et al. (Austin R M, Onisko A, Druzdzel M J, “The Pittsburgh Cervical Cancer Screening Model, A Risk Assessment Tool,” Arch Pathol Lab Med., Vol. 134, No. 5, pp. 744-750, May, 2010), and by Goldie, et al. (Goldie S J, Kuhn L, Denny L, Pollack A, Wright T C, “Policy analysis of cervical cancer screening strategies in low-resource setting,” JAMA, Vol. 285, No. 24 pp. 3107-3115, Jun. 27, 2001), and by Ellerbrock, et al. (Ellerbrock T V, Chiasson M A, Bush T J, Sun X W, Sawo D, et al., “Incidence of cervical squamous intraepithelial lesions in HIV-infected women,” JAMA, Vol. 283, No. 8, pp. 1031-1037, Feb. 23, 2000).

Model editor 102 is also configured to adapt model 100 to include one or more non-clinical proxies 106 for one or more clinical factors that are believed to influence progression of the disease. These non-clinical proxies may be identified in literature about the disease and manually selected or automatically detected using techniques such as question answering (QA), employed by DeepQA software, available from International Business Machines Corporation, Armonk, N.Y., and by the Unstructured Information Management Architecture (UIMA) framework, available from Apache Software Foundation, Forest Hill, Md. For example, if a particular country has a school-based vaccination program for the modelled disease, then school attendance data can be used as a proxy for vaccination data for that country, such as when vaccination data are not available. Similarly, other non-clinical proxies may be included in model 100, such as population data and demographic data including rural or urban population distribution, population within various distances from a healthcare facility, age data, HIV rates, and cervical cancer rates.

A model analyzer 108 is configured to identify variables 110 of model 100 and parameters 112 representing interdependencies among variables 110 based on results 114 of a meta-analysis of literature 116 associated with any of the disease, the clinical factors, and the non-clinical proxies. In one embodiment, model analyzer 108 adds each of the variables 110 as a random variable within model 100 and assumes dependencies between the random variables 110 only if a predefined minimal number of sources of literature (e.g., papers) report on such dependencies, where average values of the reported dependencies are used for the interdependency parameters 112 of model 100. Model analyzer 108 is configured to perform the meta-analysis in accordance with conventional techniques, such as are described by Sutton, et al. (Sutton A J, Abrams K R, “Bayesian methods in meta-analysis and evidence synthesis,” Stat Methods Med. Res., Vol. 10, No. 4, pp. 277-303, August, 2001), and/or meta-analysis results 114 are otherwise provided to model analyzer 108.

A model manager 118 is configured to provide values for any of the variables 110 of model 100 using known clinical data 120 and non-clinical data 122, including population data and demographic data, from available sources. Model manager 118 also preferably validates model 100 in accordance with conventional techniques based on the values of variables 110 and interdependency parameters 112.

A scenario simulator 124 is preferably configured to present model 100, or any user-specified portion of model 100, via a computer-based output device, such as a computer display. Scenario simulator 124 is also preferably configured to receive, such as via a computer-based user interface, an instruction to modify the value of any of variables 110 of model 100 and subsequently present model 100, or any user-specified portion of model 100, via the computer-based output device in order to allow any effects of such modifications to be appreciated. In this manner, scenario simulator 124 preferably supports iteratively modifying and presenting model 100 for various modelling scenarios.

Any of the elements shown in FIG. 1 are preferably implemented by one or more computers, such as by a computer 126, in computer hardware and/or in computer software embodied in a non-transitory, computer-readable medium in accordance with conventional techniques.

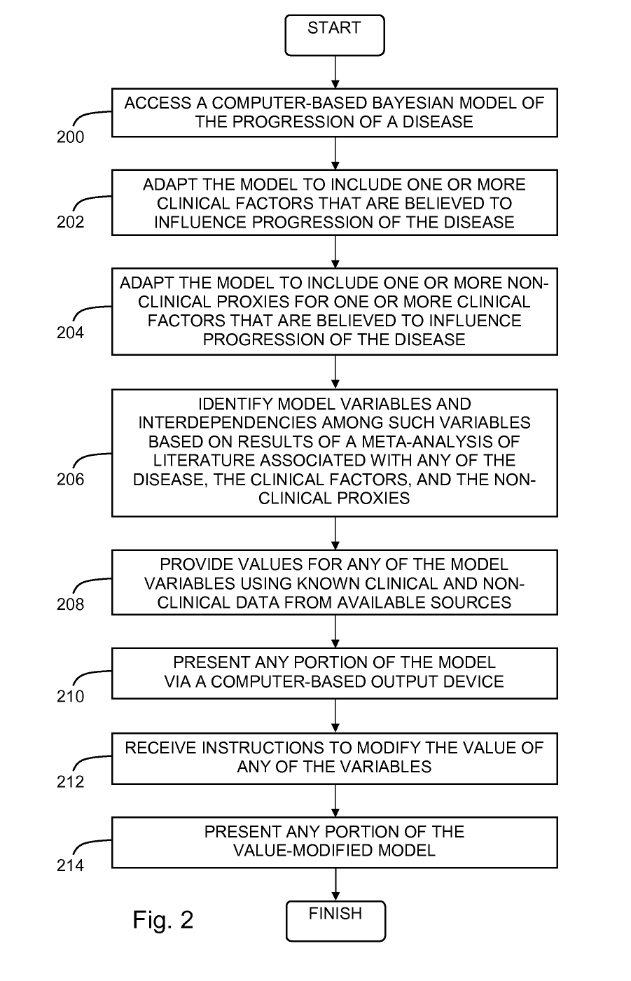

Reference is now made to FIG. 2 which is a simplified flowchart illustration of an exemplary method of operation of the system of FIG. 1, operative in accordance with an embodiment of the invention. In the method of FIG. 2, a computer-based Bayesian model of the progression of a disease is accessed (step 200). The model is adapted to include one or more clinical factors that are believed to influence progression of the disease (step 202). The model is also adapted to include one or more non-clinical proxies for one or more clinical factors that are believed to influence progression of the disease (step 204). Model variables and parameters representing interdependencies among such variables are identified based on results of a meta-analysis of literature associated with any of the disease, the clinical factors, and the non-clinical proxies (step 206). Values of the variables of the model are provided using known clinical and non-clinical data from available sources (step 208) and/or are inferred using marginal inference techniques. The model is validated based on the values of the variables and the interdependency parameters (step 208). Any portion of the model is presented via a computer-based output device (step 210). An instruction is received to modify the value of any of the variables (step 212), and any portion of the model is again presented in order to allow any effects of such modifications to be appreciated (step 214), where steps 212 and 214 may be performed iteratively for various modelling scenarios.

An implementation of the system of FIG. 1 and method of FIG. 2 may be seen in the context of the following example in which disease progression and intervention effects were modelled for cervical cancer in Kenya, where direct information about levels of vaccination, screening, and disease is extremely limited. An existing model of the progression of cervical cancer was used, which was adapted to include known factors associated with the model variables, including a variable for HIV, as well as a variable indicating the likelihood of having HIV in Kenya. The model was adjusted to include potential disease interventions, including screening and early treatment, vaccination, and associated variables. Also included in the model was a factor for whether a woman lived in a rural or urban environment, as this was known to influence the likelihood that the woman was screened for cervical cancer. A meta-analysis of relevant literature was performed, which included identifying a set of journals and other literature sources to be searched, identifying search terms, collecting the resulting papers, extracting values for associated model parameters, and inferring different marginal distributions of the model parameters. Publicly-available Kenyan databases were also used to derive further information about the population that were incorporated into the model, including the percentage of Kenyans living in rural versus urban environments, school attendance levels, the location of health facilities, and population data near such facilities. The dependencies between the variables were captured by the parameters learned from the meta-analysis. Not all model variables were known, and those that were not known were inferred from known model variables. Different variables were selected to explore different scenarios in various simulations. For example, the variable representing the level of screening was selected for exploration in several scenarios, where the level of screening reflected a current estimated distribution, as well as in a scenario where a larger portion of the population was screened, where the random variable representing the number of cervical cancer incidences was estimated in each scenario. See also Rosen, et al. (Michal Rosen-Zvi, Lavi Shpigelman, Alan Kalton, Omer Weissbrod, Saheed Akindeinde, Soren Benefeldt, Andrew Bentley, Terry Everett, Joseph Jajinskiji, Emmanuel Kweyu, Chalapathy Neti, Joe Saab, Osamuyimen Stewart, Malcolm Ward, Guo Tong Xie, “Estimating the Impact of Prevention Action: A simulation Model of Cervical Cancer Progression,” Studies in Health Technology and Informatics, IOS Press, Vol. 205, September, 2014).

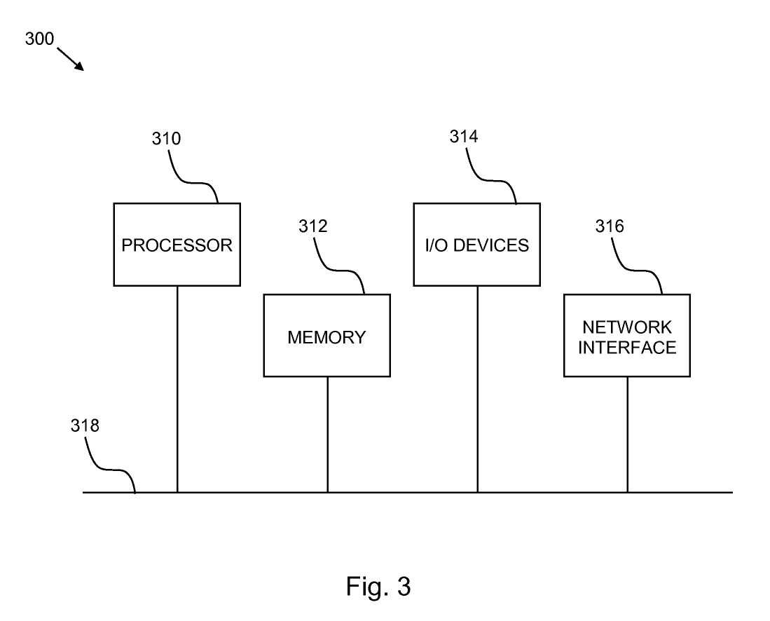

Referring now to FIG. 3, block diagram 300 illustrates an exemplary hardware implementation of a computing system in accordance with which one or more components/methodologies of the invention (e.g., components/methodologies described in the context of FIGS. 1-2) may be implemented, according to an embodiment of the invention.

As shown, the techniques for controlling access to at least one resource may be implemented in accordance with a processor 310, a memory 312, I/O devices 314, and a network interface 316, coupled via a computer bus 318 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for modelling disease progression using non-clinical information proxies for clinical information, the method comprising:
accessing a computer-based Bayesian model of the progression of a disease;
adapting the Bayesian model to include one or more clinical factors that are believed to influence progression of the disease;
adapting the Bayesian model to include one or more non-clinical proxies for one or more clinical factors that are believed to influence progression of the disease;
identifying interdependencies among variables of the Bayesian model based on a meta-analysis of literature associated with any of the disease, the clinical factors, and the non-clinical proxies;
providing values for any of the variables of the Bayesian model; and
presenting any portion of the Bayesian model via a computer-based output device.

2. The method of claim 1 and further comprising identifying any of the non-clinical proxies for any of the clinical factors that are believed to influence progression of the disease.

3. The method of claim 1 wherein the providing comprises providing the values from any of clinical data and non-clinical data.

4. The method of claim 1 wherein the providing comprises providing the values from any of population data and demographic data.

5. The method of claim 1 and further comprising validating the Bayesian model.

6. The method of claim 1 and further comprising receiving via a computer-based user interface an instruction to modify the value of any of the parameters of the Bayesian model, wherein the receiving and presenting are performed in one or more iterations.

7. The method of claim 1 wherein the accessing, adapting, identifying, providing, and presenting are implemented in any of
a) computer hardware, and
b) computer software embodied in a non-transitory, computer-readable medium.

8. A system for modelling disease progression using non-clinical information proxies for clinical information, the system comprising:
a model editor configured to
access a computer-based Bayesian model of the progression of a disease,
adapt the Bayesian model to include one or more clinical factors that are believed to influence progression of the disease, and
adapt the Bayesian model to include one or more non-clinical proxies for one or more clinical factors that are believed to influence progression of the disease;
a model analyzer configured to identify interdependencies among variables of the Bayesian model based on a meta-analysis of literature associated with any of the disease, the clinical factors, and the non-clinical proxies;
a model manager configured to provide values for any of the variables of the Bayesian model; and
a scenario simulator configured to present any portion of the Bayesian model via a computer-based output device.

9. The system of claim 8 wherein the model analyzer is configured to identify any of the non-clinical proxies for any of the clinical factors that are believed to influence progression of the disease.

10. The system of claim 8 wherein the model manager is configured to provide the values from any of clinical data and non-clinical data.

11. The system of claim 8 wherein the model manager is configured to provide the values from any of population data and demographic data.

12. The system of claim 8 wherein the model manager is configured to validate the Bayesian model.

13. The system of claim 8 wherein the scenario simulator is configured to receive via a computer-based user interface an instruction to modify the value of any of the parameters of the Bayesian model, wherein the receiving and presenting are performed in one or more iterations.

14. The system of claim 8 wherein the model editor, model analyzer, model manager, and scenario simulator are implemented in any of
a) computer hardware, and
b) computer software embodied in a non-transitory, computer-readable medium.

15. A computer program product for modelling disease progression using non-clinical information proxies for clinical information, the computer program product comprising:
a non-transitory, computer-readable storage medium; and
computer-readable program code embodied in the storage medium, wherein the computer-readable program code is configured to
access a computer-based Bayesian model of the progression of a disease,
adapt the Bayesian model to include one or more clinical factors that are believed to influence progression of the disease,
adapt the Bayesian model to include one or more non-clinical proxies for one or more clinical factors that are believed to influence progression of the disease,
identify interdependencies among variables of the Bayesian model based on a meta-analysis of literature associated with any of the disease, the clinical factors, and the non-clinical proxies,
provide values for any of the variables of the Bayesian model, and
present any portion of the Bayesian model via a computer-based output device.

16. The computer program product of claim 15 wherein the computer-readable program code is configured to identify any of the non-clinical proxies for any of the clinical factors that are believed to influence progression of the disease.

17. The computer program product of claim 15 wherein the computer-readable program code is configured to provide the values from any of clinical data and non-clinical data.

18. The computer program product of claim 15 wherein the computer-readable program code is configured to provide the values from any of population data and demographic data.

19. The computer program product of claim 15 wherein the computer-readable program code is configured to validate the Bayesian model.

20. The computer program product of claim 15 wherein the computer-readable program code is configured to receive via a computer-based user interface an instruction to modify the value of any of the parameters of the Bayesian model, wherein the receiving and presenting are performed in one or more iterations.
